(19) United States
(12) Patent Application Publication
(10) Pub. No.: US 2003/0065739 A1
(43) Pub. Date: Apr. 3, 2003

(54) Methods for independently generating a reference to desired information available from a remote source

(76) Inventor: J. Mitchell Shnier, Toronto (CA)

Correspondence Address: Mitchell Shnier, 25 Lower Links Road, Toronto, ON, M2P 1H5, CA

(21) Appl. No.: 09/965,814

(22) Filed: Oct. 1, 2001

(51) Int. Cl. G06F 15/16

(52) U.S. Cl. 709/217; 709/203

(57) ABSTRACT

Methods are disclosed for generating a desired references to a sequence or series of possibly periodically-updated references to information available on a computer network, independently of the information source.

### STATEMENT REGARDING FEDERALLY SPONSORED RESEARCH OR DEVELOPMENT

Not Applicable

### REFERENCE TO A MICROFICHE APPENDIX

Not Applicable

1. Field of the Invention

This invention relates to methods for generating a specific reference to information which is available on demand over a communications network, especially where that information is periodically augmented or updated. Notably, the methods can be used unilaterally, and independently of the source of the information.

2. Prior Art

Now that there is a wide variety of information available on demand over communications networks, including that which is updated periodically, those that want to access it need a method to easily specify which of a series of information they desire, and to determine whether that content has been updated since information was last received from that content provider. Determining whether content has been updated is important so users don't have to receive content they have previously received. And referencing updated information can be problematic since many content providers utilize new and unique references for such updated content. While content providers provide a way to reference this updated information, such as viewing and clicking through their web site, this is often undesirable since it requires one's eyes, hands, full attention, and a visit to their web site with a personal computer. The methods of the present invention provide a solution to these problems. The methods and the background for them will be described below using traditional Internet-oriented details in order to provide a detailed example, however the methods can also be used with other types of networks, such as those using wireless communication.

The Internet and other networks allow a variety of information to be sent by a content provider to a user. Examples of this information include audio, video, and text sent by a server to a personal computer. Content providers often make audio and video information available as either a traditional file which must be received, error-free, in its entirety before it can be listened to or viewed, and also as streaming media, which can be listened to or viewed while it is being received. Streaming media provides access to the information sooner, but may not be error-free, due to network congestion and other factors. In both cases, the receipt of the information is generally initiated by a user. For example, when using the Internet and the world wide web, by clicking on a hypertext link in a document displayed by a web browser. Such hypertext links have two parts; the anchor text which is displayed to the user (such as Click Here to Listen), and the reference, which is often called a uniform resource locator (such as is defined in the document RFC 2396), more commonly referred to as a URL. The URL has the format:

<protocol>://<host identifier>/<directory>/<filename>

Two examples of URLs are as follows:

### EXAMPLE 1

http://www.cnn.com/video/audio/yourmoney.ram

### EXAMPLE 2

rtsp://media.cmpnet.com/twtoday_media/2000/09/07/techwebtoday.smi

Each portion of the URL is briefly described below:

protocol indicates which protocol to use to receive the information. In the examples above, this is http for the hypertext transfer protocol, and rtsp for the real-time streaming protocol, respectively.

host identifier specifies the domain name system (DNS) host name of the server which has the content. In the examples above, this is www.cnn.com and media.cmpnet.com respectively.

directory (which in these examples, includes sub-directory information as well) has information which may indicate where on the specified server the information will be found (though the interpretation of this portion of the URL is server-dependent). In the examples above, this is video/audio and twtoday_media/2000/09/07, respectively.

filename typically specifies the exact file which is to be sent or streamed to the client, though again, the interpretation of this portion of the url is server-dependent. In the examples above, this is yourmoney.ram and techwebtoday.smi, respectively. The last characters of the filename (after the period) can be used to indicate to the client computer how to interpret the information in the file (for example, what algorithm was used to digitize audio, or the program to use to parse the file).

When a content provider periodically updates information on a web site, for example every hour with the latest hourly news report or every week with a weekly radio show, it is at the discretion of the content provider whether the URL is changed when the content is changed. In Example 1 above, the content provider has chosen to use a static URL which stays the same even though the content is updated every day. So the page displayed on a client's browser might show Click Here to Listen and the underlying hypertext mark-up language (HTML) might be as follows:

<A href=“http://www.cnn.com/video/audio/yourmoney.ram”>Click Here to Listen</A>

One advantage of this static URL method is that a web page or other device referring to the audio URL can always specify the same URL in its hypertext link, and the most recent content will always be received. However, there is no way to tell from the URL whether its content has been recently updated, nor any way to reference content from previous days or weeks.

In Example 2 above, the content provider has chosen to use a changeable URL which in this case appears to include a date code in the directory portion of the URL. In this case the page displayed on a client's browser might again show Click Here to Listen, but the underlying hypertext could be as follows:

<A href=“rtsp://media.cmpnet.com/twtoday_media/2000/09/07/techwebtoday.smi”>Click Here to Listen</A>

An advantage of this changeable URI method is that previous shows can be stored and available on the content provider's server, and each show can be individually specified and received by the client if they so choose. The content provider's web site will usually have a web page or look-up procedure to access older shows, as well as a hypertext link which is updated with the most recent show's URL. However, this means that the content provider has to periodically update their web site to reflect the new URLs.

For a variety of reasons, some types of content, such as streaming Internet audio, is often difficult to find using current conventional Internet search engines. And even when it is found, the variety of content of interest to a user is typically located at many different web sites, and buried several clicks deep at each.

There is therefore a need for third-party directories, scheduling software and databases to store references to such updated information, for example in a specialized central database. Such a central database would include the URLs for the content, as well as other information, such as the URL for the web page describing the content, along with other information to describe and to help in searching for the content.

Such a database could provide the very desirable capability of enabling Internet audio listeners to have all their selected audio links displayed on a single web page, or available to a device specialized for playing Internet audio, which does not have the powerful user interface of a personal computer monitor and mouse available. Such a capability would promote listening to Internet audio, and can therefore drive more traffic to the content providers' web sites.

However, as described above, content providers often change the URL for content every time it is updated. Prior art requires that third-parties which desire to reference this periodically-updated information have a bilateral business and technical relationship established with the content provider so the content provider can inform the third-party when the content has been updated, and what the new URL for that updated information will be.

Such a technical relationship may include a control message or an electronic-mail being sent by the content provider to such third-parties with these update details, or even sending the content itself. However, there would be substantial benefits in eliminating the work and time required in creating and maintaining these relationships, and in avoiding the technical problems and inflexibility of transfer of this information. Also, this requirement for a relationship being established restricts the choice of content providers' whose information is available to such third-party sites, and slows and complicates the growth of services. As an example, conventional search engines on the Internet have no relationship with most of the sources of the content indexed. And this absence of barriers and entanglement has contributed to the rapid growth and acceptance of the Internet.

However, eliminating the need for such bilateral relationships would require that the third-parties be able to update their URLs referencing the updated information independently of the content providers—that is, without any direct information from the content providers about the timing of when the updated content is available, nor the updated URLs for that content. It would therefore be very desirable if such third-parties were able to unilaterally generate the URLs for content for particular days or shows, without having any relationship established with the content providers, as this would dramatically reduce the amount of data which needs to be stored, and eliminate the need to update the database every time new content became available. Also, there is a need for users to be able to track what content they have already received, and when content has been updated, so that users are not presented with content they have already received, if they so choose.

Other prior art which modifies URLs has focussed on third-parties modifying URLs displayed to users so that the requests for content first go to the third-party, which then provides redirection to the content provider. For example U.S. Pat. No. 5,870,546 to Kirsch and U.S. Pat. No. 5,761,683 to Logan et al. both modify URLs referencing a content provider so that the request first goes to the third-party which then either uses information contained in the request to construct the redirection to the content provider, or uses information in a look-up table at the third-party to construct the redirection to the content provider. However both these methods require the full and complete URL to be known in advance. That is, this prior art does not solve the main problems of reducing storage and transmission requirements of known URLs, nor of being able to reference newly created content or be able to determine whether that content has been updated.

Note that the discussion above used audio content and the Internet and the world wide web as an example, but the same concepts apply for other periodically-updated content as well, such as video and text, and other networks, such as those based on Cable TV infrastructure and wireless technologies.

### OBJECTS AND ADVANTAGES

Accordingly, several objects and advantages of the present invention are that it enables a central database or listening client to unilaterally (that is, without periodic information from the content provider) track when updated content is available, and to generate the reference to that content, and to older content as well.

Other objects and advantages are that storage and update requirements for network references are dramatically reduced, references can be generated at any time including in advance of the content provider posting updated references on their own web site, and listening clients can avoid receiving content which they have previously received.

### SUMMARY

Methods are presented to generate references to information available on demand, over a communications network, even if that information is periodically updated or augmented. And these methods can be used without needing to contact, or receive periodic information from the information sources.

### BRIEF DESCRIPTION OF THE DRAWINGS

FIG. 1 shows an exemplar configuration of the main components involved in the present invention, including a communications network which interconnects a content provider, a central database of content available on the communications network, and a client.

FIG. 2 shows a flow chart used for a method used to handle different types of URLs.

FIG. 3 shows a web page served by the central database which could be used to submit database entries.

FIG. 4 shows a flow chart of a method for how URLs and templates are used to play content.

### DETAILED DESCRIPTION OF THE INVENTION

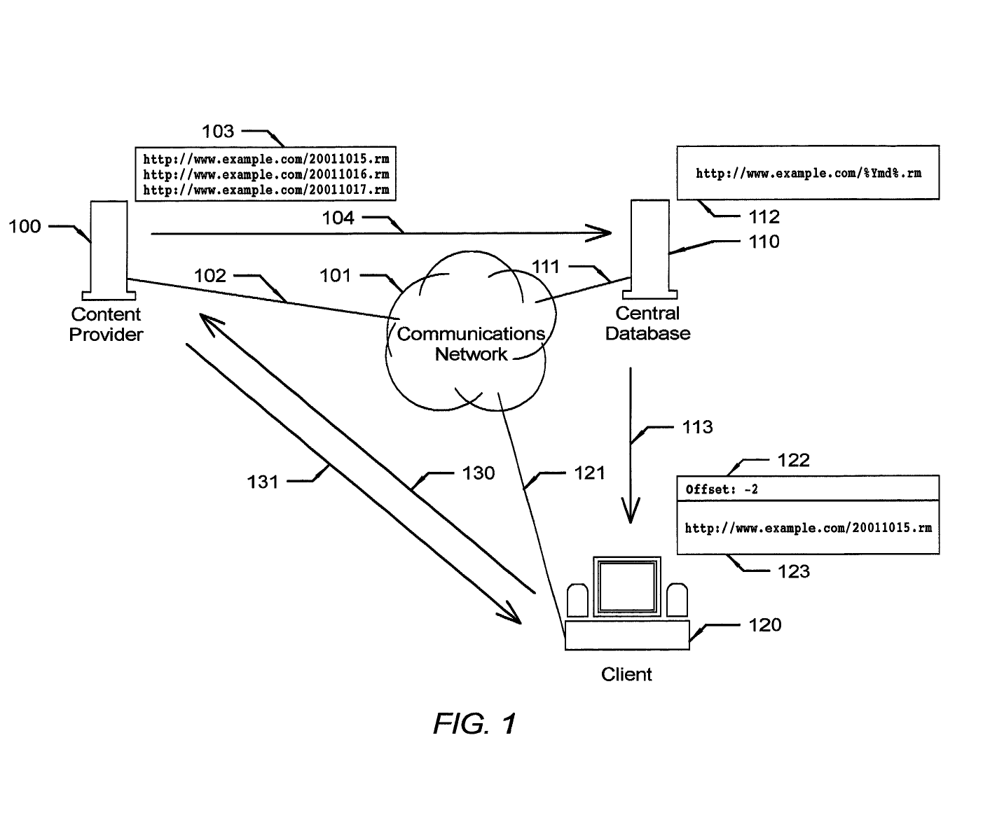

The present invention can be used with any type of content, use any type of computer systems and any type or combination of communications networks. While it can be used with client devices such as personal computers, it is particularly well-suited to devices which have simpler user interfaces, such as streaming audio network appliances. However, in order to present an example based on familiar networks, protocols and devices, the description below is based on the content being streaming audio, Communications Network 101 in FIG. 1 being the public Internet, Content Provider 100 being a world wide web server providing streaming audio, Central Database 110 being a world wide web server and database, and Client 120 being a personal computer with loudspeakers.

There are two types of streaming audio, live and archived:

Live streaming audio is encoded and sent by Content Provider 100 to all listeners simultaneously. So a client computer receiving this audio will receive whatever is being produced at that time, with no control over the audio. This is analogous to tuning into a radio station, they send whatever they want whenever they want to, and your only option is whether you listen to it.

Archived streaming audio is content which has previously been stored at Content Provider 100, and a every client computer receiving this audio will receive the stored audio beginning at the beginning, regardless of when they start listening. This is analogous to playing a compact disc. In this case, the audio can be paused, advanced or set back to any point (that is, time from the beginning) in the content, and resumed anytime, as desired by each client computer receiving the audio.

Content Provider 100 and Central Database 110 are connected to the Internet or another network in well-known fashion, using communication circuits 102 and 111, respectively, which could be dedicated high-speed data circuits, as is common for server computers.

Client 120 can be connected to the Internet or another network in well-known fashion, using communication circuit 121, which could be a dial-up circuit using a modem and conventional analog telephone connection, or any other method. Significantly, communication circuit 121 could also be or include a wireless link, such as those provided by private radio connections such as Bluetooth and IEEE 802.11, and public radio connections such as public cellular telephone service, digital radio and satellite radio, especially using multicasting service to reduce total bandwidth requirements.

Note that any number of Content Provider 100 servers and Client 120 computers could be used, though only one of each are shown in FIG. 1.

The description below for FIG. 1 is in two phases. The first phase is adding URLs and templates 112 to Central Database 110 to create and update Central Database 110. The second phase is for Client 120 to fetch URL templates 112 from Central Database 110 so that specific content can be requested from information sources such as Content Provider 100.

While the description below for adding to Central Database 110 is based on manual procedures, as will be apparent to those familiar with programming such as in JavaScript, some parts of this process could be automated.

First, web sites with audio content of interest, such as Content Provider 100, are found, and those web sites are navigated to find the hypertext links to audio content. Such hypertext links consist of two parts, the anchor text (such as Click Here to Listen) which is visible to users, and the hypertext reference (such as http://www.example.com/20011015.rm) which is the URL. While the URL is not normally visible to a user, there are many methods which can be used to obtain it, and these include:

many browsers show the URL on the browsers's status line when the mouse is rolled over the hypertext link

many browsers allow clicking the right mouse button when the cursor is over the hypertext link, and a menu pops up which allows the URL to be displayed and saved

many browsers allow the hypertext mark-up language (HTML) of the entire page to be displayed, and this will show the URL

some browsers support JavaScript, which can then be used to save the URL

a protocol analyser (optionally as software resident on the same client computer) can be configured with a filter to trap specific URLs, such as those for streaming media

If the audio is archived, and previous shows are available, then several URLs should be examined. This could be done from Central Database 110, as shown by arrow 104, or by another computer with access to Content Provider 100, not shown.

Similar to file naming on a computer, each URL must be unique, and the scheme for generating such unique URLs is determined by the administrators of the server computers at Content Provider 100. Examining these URLs 103 reveals that some parts of the URLs are the same (the non-changing part, here “http://www.example.com/” and the “.rm”), and some are different (the changing part, here “20011015”, “20011016”, and so on). Often, unique URLs are generated using a sequential number, or using digits and letters based on the date when the content was produced or first made available. Here, the changing part of URLs 103 appears to have a date code in the following format (left to right):

4-digit year (2001)

2-digit month (10)

2-digit date (15, 16, and 17)

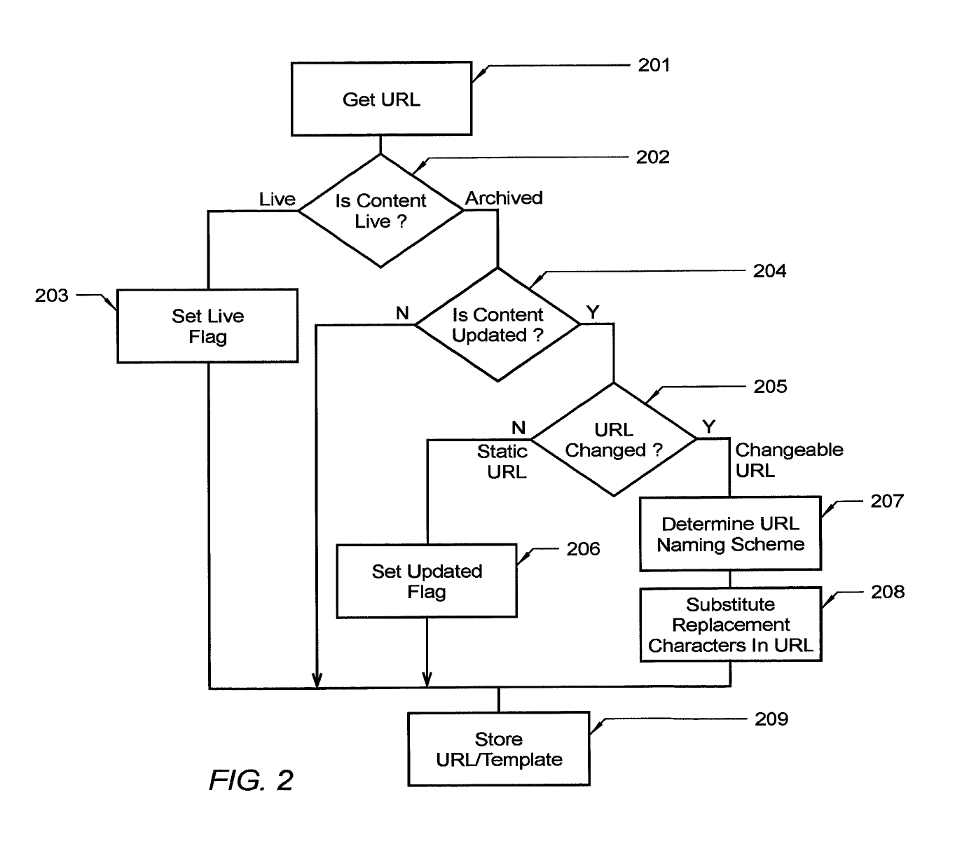

Depending on the URL naming scheme used and the particular sequential numbers or dates in the URLs examined, it may be necessary to examine additional URLs to confirm exact details, such as whether leading zeros are used for dates less than 10 (that is, would the fifth of the month be indicated by “5” or “05”), whether specific digits are the month or date, and so on. Further details of the classification of URLs will be described for FIG. 2, below.

Once the URL naming scheme has been determined, the URL can be changed into a template by substituting replacement characters for the changing part of the URL. While many such schemes are possible, the following describes a detailed example. Those familiar with the technology would be able to produce similar results using other methods equally considered part of the present invention.

The following individual replacement characters are used to generate the corresponding replacement described (with examples given):

d—2-digit date with leading zero if date is a single digit (01 to 31)

j—day of the month without leading zeros (1 to 31)

m—2-digit month number with leading zero if month is a single digit (01 to 12)

M—3-letter lower-case month (jan to dec)

O—3-letter month initial capital, remainder lower case (Jan to Dec)—that is the capital letter “O”

P—month, initial capital, remainder lower case (January to December)

n—month number without leading zero (1 to 12)

W—2-digit week number, with leading zero if week is a single digit (the first week of the year is 01)

Y—4-digit year (for example, 2001)

y—2-digit year (for example, 01)

xxxxxxxxxx—starting date and increment for date codes, exactly 10 digits, and always in the format; 4-digit year, 2-digit month, 2-digit date, and 2-digit increment (that is, by how many days each offset count increments the replacement)

Cx—sequential counter, starting at number x—to force a fixed-length field (such as 0018 instead of 18), specify leading zeros to produce the desired field length, such as C0001, for a four-digit counter that starts at 0001

In addition, some way of delimiting the replacement characters from the non-changing part of the URL is required. One way would be to use a pair of characters that does not normally appear in a URL, such as percent signs (“%”).

Note that from the above list, the replacement character for the 4-digit year is a “Y”, for the 2-digit month is an “m”, and for the 2-digit date is a “d”. Therefore, converting the URLs 103 into a template would result in the following:

http://www.example.com/%Ymd%.rm

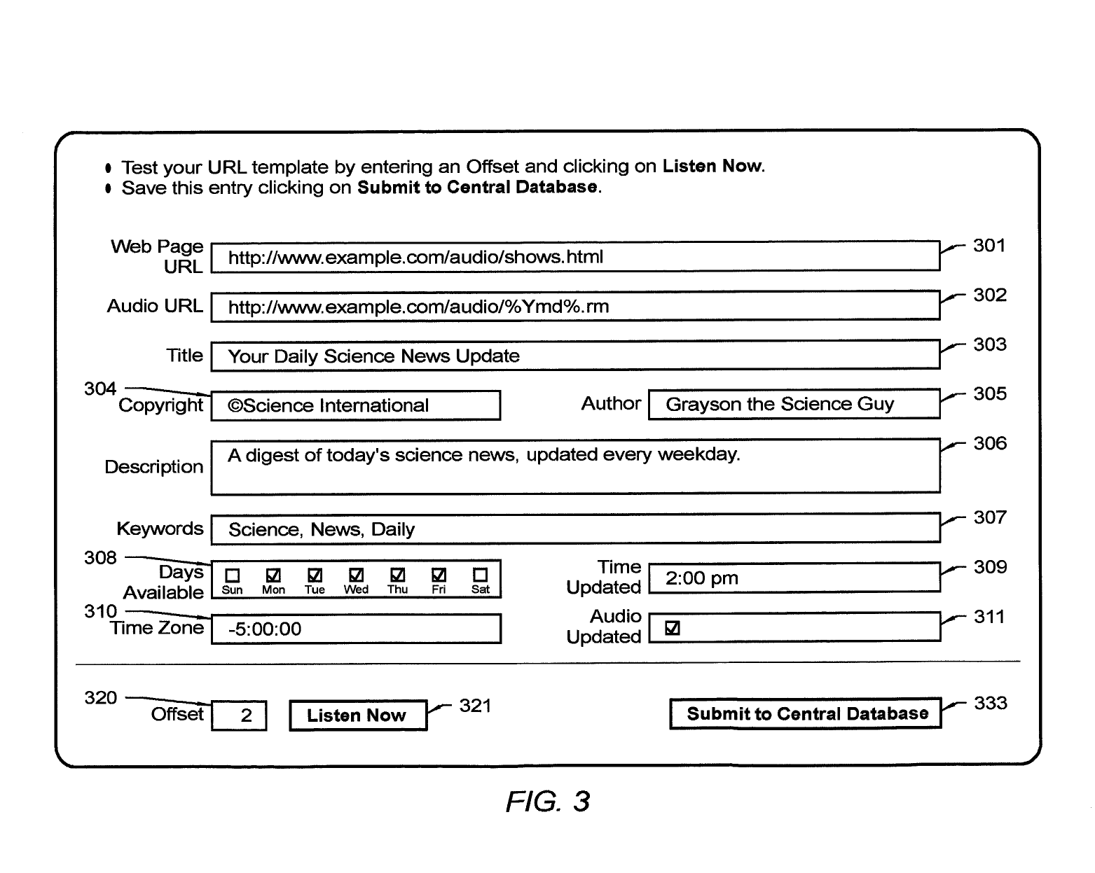

And this is shown as template 112. An example method for entering this template 112 is shown in FIG. 3, as will be described below.

When a Client 120 wishes to listen to the audio referenced by the above template, either Central Database 110 or Client 120 would convert the template back into a URL by parsing the replacement characters and substituting the current date as required. For example, if the current date is Oct. 17, 2001, then the above template would produce a URL of http://www.example.com/20011017.rm.

A very important requirement is the ability for the Client 120 to specify an offset to be applied before the date substitution occurs. For example, if an offset of −2 is specified, then the resulting URL would instead be http://www.example.com/20011015.rm, and the audio from two days ago could be heard instead of the audio for the current day. The allows a Client 120 to easily listen to any archived show specified in a template by simply entering different offsets. The most recent show would generally be at an offset of 0 or −1 (if today's show has not yet been made available), and older shows would be at greater negative offsets.

The above replacement characters provide a variety of date-oriented replacements. Since no date is provided in the template above, the date is relative to the current date. However, depending on the URL naming scheme used by the content provider, it may be desirable to have the date replacements be relative to a specified date. As shown in the list above, this specified date is included in the template using a 10-digit field. So if instead the template was specified to be as follows:

http://www.example.com/%Ymd2000010101%.rm

Then the URLs produced will be relative to Jan. 1, 2000. So specifying an offset of 5 would result in a URL of http://www.example.com/20000105.rm. This is very useful for listening to archived programs for previous years. Therefore, by specifying of offsets of 0 through 365, all shows for the year 2000 could easily be received.

Some shows are not produced every day. For example, a show might be produced every Sunday. In this case, a 2-digit increment can be specified as the last two digits of the 10-digit date field. The date substitution algorithm multiplies the offset by the increment before doing the date calculation. Therefore, by specifying a template as follows:

http://www.example.com/%Ymd2000010207%.rm

A base date of Jan. 2, 2000 is specified (which was a Sunday), with an increment of seven. Using this template would produce the following:

an offset of 0 would produce a URL of http://www.example.com/20000102.rm (the first show of the year),

an offset of 1 would produce a URL of http://www.example.com/20000109.rm (the second show of the year), and

an offset of 2 would produce a URL of http://www.example.com/20000116.rm (the third show of the year), and so on.

Therefore, it is very easy to listen to specify and listen to shows that are produced at intervals of a fixed number of days.

Some shows are produced only on particular days, such as every weekday. In this case, the days available field, as is described below for FIG. 3, is used when the template is submitted to Central Database 110. The increment in the specified date is then ignored, and instead the date substitution algorithm only counts days for which the audio is available when applying the offset. For example, a template of http://www.example.com/%Ymd2000010301%.rm (which specifies that the base date is Monday, Jan. 3, 2000) with a days available field set to weekdays only and an offset of seven would produce a URL of http://www.example.com/20000112.rm (which is the seventh show after the first one of the year, and is the show for Wednesday, Jan. 12, 2000—since the days available field specified that there are no shows produced for Saturday, Jan. 8, 2000 and Sunday, Jan. 9, 2000).

Rather than using a date as part of a URL, some content providers simply sequentially number the shows. For example, URLs 103 could have been the following:

http://www.example.com/1.rm

http://www.example.com/2.rm

http://www.example.com/3.rm

In this case the template would be http://www.example.com/%C1%.rm, as this specifies a sequential counter beginning at 1. When listening, an offset of seven would then produce a URL of http://www.example.com/8.rm, which is the seventh show after the first one.

Some sites use URLs with a fixed length sequential number field. For example, URLs 103 could have been the following:

http://www.example.com/0101.rm

http://www.example.com/0102.rm

http://www.example.com/0103.rm

In this case the template would be http://www.example.com/%C0101%.rm, as this specifies a sequential counter beginning at 101, and the digits field must always be exactly four digits. When listening, an offset of seven would then produce a URL of

http://www.example.com/0108.rm, and an offset of −2 would produce a URL of

http://www.example.com/0099.rm.

Note that this method does not require that the replacement characters be contiguous, since more than one pair of delimiter characters (with one or more replacement characters between each pair) could be used in the URL.

Furthermore, other methods of indicating where the character replacements are to occur could be used, for example, by using other special characters, defining a programming object, or a database structure.

Not all URLs have a pattern that can be deduced without further information from the content provider. For example, the content provider might be encoding additional information into the URL (such as a username or other authentication information), or could be using software which produces unique filenames based on proprietary algorithms. Also, the content provider might be using the services of a content delivery network (CDN) that uses distributed caching of content, and this CDN may require a URL naming scheme that includes other information such as geographic location in order to optimize network traffic. In these situations, all URLs would be read into a table, and an index number assigned to each entry. The offset would then specify from which entry of the table to obtain the URL. A value associated with the table would indicate how often to check Content Provider 100 for new URLs to add to the table.

Central Database 110 therefore stores the templates, days available fields, as well as other information which will be described below for FIG. 3.

The generation of URLs from templates could be done by Central Database 110, in which case arrow 113 represents the transfer of URL 123 to Client 120. This would require that offset 122 would first be transferred from Client 120 to Central Database 110. Alternatively, a preferred embodiment would be for URL 123 to be generated by Client 120, in which case arrow 113 represents the transfer of template 112 to Client 120, and offset 122 would stay local to Client 120. This provides faster response time and greater independence to Client 120 requesting new content, since the URL is generated locally.

In either case, Client 120 now has URL 123 of the content desired, and sends request 130 for the content to Content Provider 100, which sends the corresponding streaming audio 131 back to Client 120, which plays streaming audio 131 through the loudspeakers on Client 120.

In an alternative embodiment, Client 120 could instead store streaming audio 131 for playback at a later time. For example, Client 120 could be an automobile radio with a wireless connection 121, which gathers content during the night, available for playback during the next commute. In this case the content for streaming audio 131 could also be received in other forms, such as a non-real-time file transfer, which has the benefit of error-correction, since real-time playback is not required. Also, content from more than one content provider could be requested and simultaneously received, providing greater network utilization and shorter download times.

In another alternative embodiment, Content Provider 100 would directly send Client 120 template 112, so Client 120 can generate URLs for the most recent, or any selected show, without having to use an index at Content Provider 100, nor requiring a Central Database 110.

In another alternative embodiment, Central Database 110 would store all URLs 103, along with an index value for each. Offset 122 would then be used to specify the index value so that a selected URL can be retrieved. This alternative embodiment would be most useful when a pattern for URLs 103 cannot be determined.

FIG. 2 shows the classification and handling of different types of URLs from content providers. The first step 201 is to obtain the URL, for example using one of the methods described for FIG. 1 above. The next step 202 is to determine whether the content is live or archived. This can be done by reading the content provider's web site, examining the header bits of the content, or querying the audio player. If the content is live, then the live flag is set in step 203, and the URL is stored in step 209.

If the content is not live, then it is archived, then the next step 204 is to determine whether the corresponding content is updated. That is, are new shows produced periodically. This can typically be determined by navigating through the web site, and understanding the content. For example, if it is a one-time special report produced for a special event, then the content is not updated, and the URL can be immediately stored, as shown at step 209.

However, if the content is an hourly news update or a weekly feature, then the URL for different shows needs to be examined to see if it is changed or not, either by requesting different shows, or by requesting the content at a later time and noting whether the URL is different when the content changes. Therefore, in step 205 the URLs for updated content are examined, and if they don't change (that is, the URL is the same, but the content at later times is found to be different), then the updated flag is set at step 206, and the URL is stored at step 209.

If the URL does change when the content is changed, then at step 207 one or more of the URLs (for example, URLs 103 in FIG. 1) need to be examined to determine what the URL naming scheme is. For example, it is common to find that for content which is updated daily, or less often, generally the 2-digit or 4-digit year, 2-digit month and 2-digit date are used either in the directory part of the URL, or in the filename part. However, it is also common to see the month spelled out with letters, week numbers, and sequential numbers.

Once the URL naming scheme has been determined, at step 208, the template is produced by deleting the characters of the URL name which change and substituting the replacement characters required to generate that naming scheme, and surrounding the one or more sequences of replacement characters with the percent-sign delimiters (for example, template 112 in FIG. 1). The template is then stored at step 209.

The purpose of gathering these URLs and templates is to build a database or directory of audio sources, and FIG. 3 shows how these URLs and templates could be stored.

Central Database 110 in FIG. 1 would have software which presents a user at a computer running web browser software with a blank form, which the user would fill in. A sample filled-in form is shown in FIG. 3, and those fields will now be described. Note that the intent of this description is to show how templates could be entered into a database, and the other fields required in this database would depend on how the templates are to be used. The example below assumes that these templates would need to be indexed by keyword to facilitate searching, have descriptions to assist selection of entries of interest to a user, and have other information to aid in describing the availability of updates to the content, as described below.

The URLs 103 in FIG. 1 would typically be obtained from an HTML page viewed using a web browser, and that HTML page would have a URL, which would be entered into Web Page URL field 301. Note that while this URL could simply be typed in to the field, it could also be entered using a copy-and-paste, JavaScript-based, or other method which would facilitate this data-entry process and reduce typing errors.

Template 112 shown in FIG. 1, and constructed at step 208 of FIG. 2 would be entered into Audio URL field 302. HTML web pages typically have a descriptive title, and this would be entered into Title field 303. This title could be edited before entry to the database to provide additional details. Along with an indication of whether the content is live or not, streaming audio headers generally include copyright and author fields, and these would be entered into Copyright field 304 and Author field 305, respectively. Again, this could be done manually, or through a JavaScript or other method which automates the process.

Through reading the content provider's web site, or listening to typical audio, a description of the content would be written, and entered into multi-line Description field 306, along with keywords, into Keywords field 307, to be used for later searching of the database.

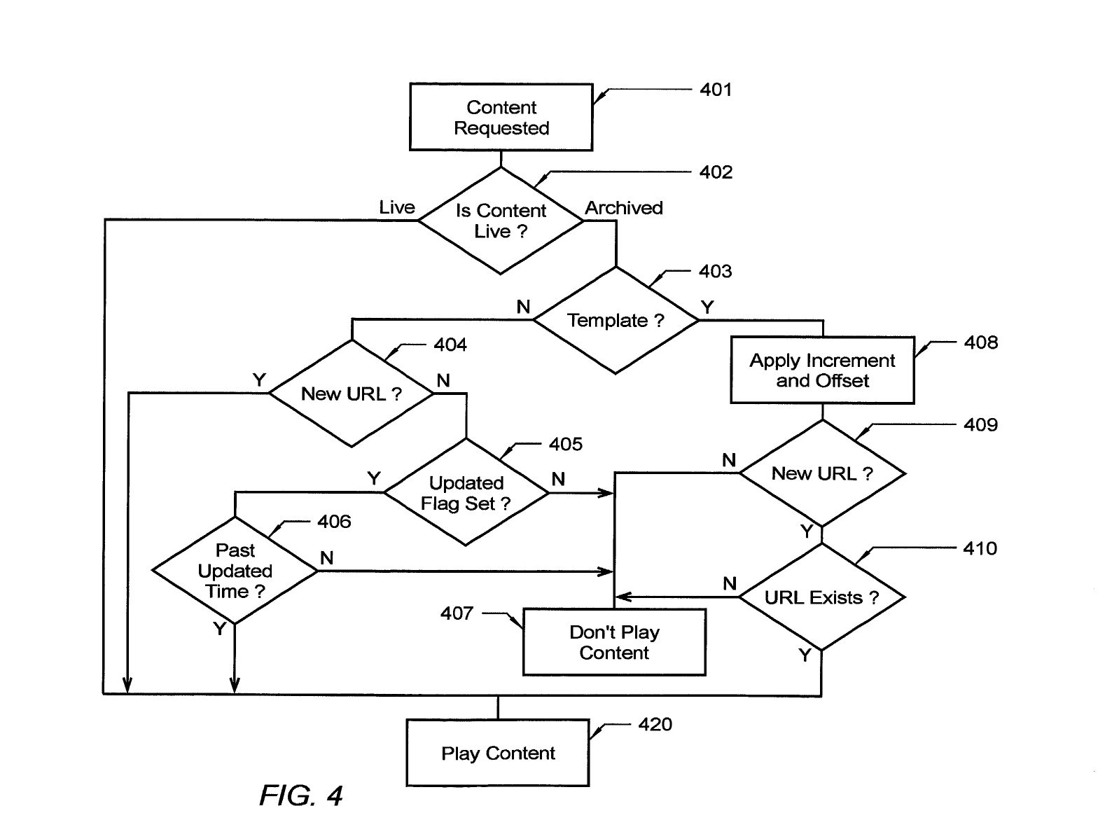

As described above, some content is updated on only particular days of the week, and this would be indicated by checking the corresponding checkboxes in Days Available field 308. On the days when content is available, it will generally be posted at a particular time each day, and this time would be entered into Time Updated field 309. The use of this field will be described in FIG. 4.

Since Client 120 in FIG. 1 may be in a different time zone than Content Provider 100 in FIG. 1, so the time zone of Content Provider 100 is entered into Time Zone field 310, so that Time Updated field 309 can be properly interpreted.

If the filename of the audio URL does not change when its content is updated, then Audio Updated flag 311 is checked, as described in step 206 of FIG. 2. Again, the use of this field will be described in FIG. 4.

If a template was entered into Audio URL field 302, then the generation of a URL from that template can be immediately tested by entering an offset into Offset field 320 and clicking on Listen Now button 321 to hear the content, to ensure that a valid URL is generated.

Finally, once all fields have been entered as desired, the Submit to Central Database button 333 is clicked to store the fields into Central Database 110 in FIG. 1.

While the use and scheduling of the audio referenced by the URLs generated by the templates is up to application software which would make use of the present invention, FIG. 4 and the following describes a possible algorithm.

In step 401, a user at Client 120 in FIG. 1 will request audio using template 112 in FIG. 1 and possibly specify an offset 122 in FIG. 1, and Client 120 will receive the database record as shown in FIG. 3, and transferred as arrow 113 in FIG. 1.

The live flag will be examined in step 402, and if set, the audio can be directly retrieved using the received URL, and played, as shown in step 420. This step 420 includes keeping a record of the following:

which URL was played,

which offset was specified

when the content was played, and

if it is archived audio, how much of it was heard.

This information can be later used to ensure that listeners have the option of not hearing content which they have heard before, and so that content which was not heard in its entirety can be resumed at the exact point where listening was stopped. A further feature is that such interrupted audio can be resumed a few seconds before the interruption, in case that interruption was in mid-word or mid-sentence.

If at step 402 the content is determined to not be live, then it is archived audio. Therefore, at step 403 the received URL or template is examined to determine whether it is a URL or template. This would by done by checking for the presence of delimiter characters.

If no delimiter characters are found, then it is a URL, and at step 404 the record of previously played URLs would be examined to check whether this is a new URL, or whether it has previously been played. If this is a new URL, then the audio can be directly retrieved using the received URL, and played, as shown in step 420.

If this is not a new URL, then at step 405 the updated flag, set at step 206 of FIG. 2 and Audio Updated field 311 of FIG. 3 is checked to see whether this audio content is updated without changing the URL. If the updated flag is set, then at step 406 a check is done to see whether the content has been updated since this URL was last played. This is done by comparing the Time Updated field 309 in FIG. 3 to the time this URL was last played according to the record, taking into account the time zone of Content Provider 100, as entered in Time Zone field 310 of FIG. 3, and the time zone of Client 120 in FIG. 1. If the content has been recently updated, then the audio can be directly retrieved using the received URL, and played, as shown in step 420.

If the audio has not been updated since it was last played, then the user will have the option that the audio will not be played, as shown at step 407. That is, depending on user preference, other content of interest to the user could be played instead, or a prompt could be displayed to the user telling them that the audio has not been updated since they last listened, giving the choice of skipping to the next audio of interest to the user, or playing the audio anyways (perhaps because the user wants to check whether the audio was in fact updated sooner than expected).

If a template was received, as determined in step 403 described above, then the increment and offset, if specified by the user, will be applied at step 408, and a URL will be generated, as described for URL 123 in FIG. 1. Similar to step 404, this URL will be examined in step 409 to see whether it is a new URL, or whether it has been played already. If it is not a new URL, then the content may not be played, as described for step 407 above.

If, in step 409, the URL is found to be new, then the URL will be checked at step 410 to see whether the content it references exists yet, by contacting Content Provider 100 in FIG. 1. and if not, the content will not be played, as described for step 407 above. If the content does exist, then it will be played, as shown in step 420.

Conclusions, Ramifications, and Scope

Accordingly, the reader will see that the method presented to unilaterally generate updated references to periodically updated content on a communications network enables one to build a centralized database of all information on the network, or to create a personalized directory of sources of information, and those references can compactly represent a sequence of information available, and be used to always reference the most up-to-date information.

Furthermore, this method has additional advantages, such as the following:

it can provide a log of which content has been received, for usage monitoring or targeting advertisements

the references to the most up-to-date information can be generated locally by the user, with no need to contact the content provider for these references, so the user can have a different type of player or user-interface than that supported by the content provider

it provides a method to easily individually reference all older content, as well as the newest

it provides a dramatic reduction in the storage required to reference the content, since only a template for each series of related references needs to be stored

the references to the information of interest to a user can be presented in any format, such as all on one screen, independent of how the content providers make the references available and independent of how many screens content providers require to make the references available

it provides a dramatic reduction in the updates which would be required to a database of the content, since the updates are automatically applied when the references are used

a relationship or special actions or arrangements with content provider are not required, thereby reducing the overhead of registrations and increasing flexibility,

references information which is already freely available over a communications network, so presents no copyright issues,

can support digital rights management, control over listening, monitoring listening habits and durations, and subscription-based services and other enhancements, since the central database has all references, and the player software on the client can report back to the central database all actions,

supports any predictable content-naming scheme, for example including any date or sequential number component or combination of these, relative to the current date or to an absolute date, even if the content is not updated daily (for example only on particular days of a week, or only every other Thursday),

supports any unpredictable content-naming scheme by indexing all content available, and periodically checking for new content,

handles live and archived content,

handles both static content references (for which the content is updated, but the name of it is not) and changeable content references (for which the content is updated, along with the name),

it provides two methods to determine whether content has already been received:

tracking the time that content using static content references has been received and at what time it is updated, and

tracking which content using changeable content references has already been received,

it accommodates time zone differences between the content provider and the user,

handles audio, video or other types of content, and

can be combined with a system to store a plurality of periodically-updated content references of interest to a user, so the user could start or hop around a sequence of content as desired, assured that only new content, of interest to the user, will be received.

Although the description above contains many specificities, these should not be construed as limiting the scope of the invention, but as merely providing a concrete example of some of the presently preferred embodiments of the present invention. For example:

the user could be receiving the content at an audio appliance intended to only receive Internet audio rather than a full personal computer

the content could be digitized video

the content could be fully downloaded in advance of listening rather than streamed so the audio is played while it is received

a graphical user interface could be used to specify replacement character details, such as capitalization, number of letters to use, whether to include leading zeros, and so on

other URL formats could be generated, and other methods of representing them could be used

wireless devices, such as those based on private wireless LANs, public cellular telephone service, digital broadcast radio and digital satellite, could be used to receive the content

the audio could be stored on the client device before being used, to enable data to be multicasted to many clients, yet listened to when convenient to the listener, or to enable the transmission to be done when network traffic is lower

the content could be sent to multiple users at the same time, for example through multicasting technologies, possibly also using the above wireless or storage features

Thus, the scope of the invention should be determined by the claims and their legal equivalents, rather than by the examples above.

Therefore, what I claim as my invention is:

1. A method of representing a sequence of references to information available on a communications network, said sequence of references changing in some predictable pattern, said method comprising the steps of:
a) locating examples of said sequence of references, where each reference consists of;
a non-changing part, which is at least some of the characters of said reference which are the same for all references in said sequence of references, and
a changing part, which is the remaining characters of said reference, said changing part resulting in each reference of said sequence of references being unique,
b) examining said changing part to determine said predictable pattern,
c) creating a template, said template comprising at least;
said non-changing part, and
one or more replacement indicators selected to both indicate said predictable pattern, as well as the position in said reference where said predictable pattern occurs, and
d) storing said template,
e) utilizing said template to later reconstruct any reference of said sequence of references, the specific reference reconstructed being specified according to a supplied index value,
whereby storage requirements are reduced, and the need to update said storage whenever an additional reference in said sequence of references becomes available is eliminated, and whereby any desired reference can be easily specified through said index value.

2. The method of claim 1 wherein said information is stored at a content provider, and a plurality of said templates are stored at a third-party database.

3. The method of claim 1 wherein said information is stored at a content provider, and said template is also available from said content provider.

4. The method of claim 1 wherein said replacement indicators produce output selected from the group consisting of the:
a) date, with or without a leading zeros for single-digit dates, as specified when selected
b) month number, with or without a leading zero, for single-digit months, as specified when selected
c) three-letter abbreviation for the month, all lower-case, with only the initial letter capitalized, or all capitalized, as specified when selected
d) full month name, all lower-case, with only the initial letter capitalized, or all capitalized, as specified when selected
e) week number, with or without a leading zero, for single-digit weeks, as specified when selected
f) four-digit year
g) least-significant two digits of the year
h) count value, relative to a specified starting number, and with or without leading zeros, as specified when selected
where the above date-related values are relative to either a specified date or to the date when said template is used to generate an updated reference, as specified when said template is created,
whereby templates can be created which contain any combination of date and count components, along with non-changing characters,
whereby said templates can be used to generate references to information which is periodically updated.

5. The method of claim 1 wherein said index value is used to generate references to newly-created information.

6. The method of claim 1 wherein said template is sent from content provider directly to user.

7. The method of claim 1 further storing information of when said information which is periodically updated is updated.

8. The method of claim 1 wherein said index value is a numerical offset relative to the current date.

9. The method of claim 1 wherein said index value is a numerical offset relative to a specified absolute date.

10. The method of claims 8 or 9 wherein an increment value is specified to indicate the interval between updates.

11. The method of claim 10 wherein a previous or subsequent reference is generated from said template by multiplying an offset times said increment value and adding base date or count value used for the calculation of the reference.

12. A method of representing a series of references to information available on a communications network, comprising the steps of:
a) locating all references in said series of references,
b) building a table of said references, associating with each entry in said table an index value,
c) storing said table,
d) utilizing said table to later return any reference of said series of references, the specific reference returned being specified according to said index value,
whereby any reference can be easily specified through said index value.

13. The method of claim 12 wherein the said series of references is periodically examined to determine whether any new references have been added to said series of references.

14. The methods of claims 1 or 12 wherein said index value is a numerical offset used to specify the particular reference desired.

15. The methods of claims 1 or 12 wherein a record is maintained of references and the time and date used, said record being used to determine whether references have already been used, whereby users can have the choice of not again receiving information which they have previously received.

16. The methods of claims 1 or 12 wherein a record is maintained of the amount of information received, such that if information reception is interrupted it can later resumed, even from a different listening location, optionally a predetermined number of seconds earlier, whereby a user can control when they complete receiving information and the last said predetermined number of seconds of information can be repeated to aid in recalling where the information was interrupted.

17. The methods of claims 1 or 12 wherein said information is streaming audio.

18. The methods of claims 1 or 12 wherein said network is the public Internet.

19. The methods of claims 1 or 12 wherein said references are uniform resource locators.

20. The methods of claims 1 or 12 wherein said information is used as it is received.

21. The methods of claims 1 or 12 wherein said information is stored as it is received, available to be used at a later time,
whereby error-free and non-real-time transmission can be used to both improve the quality of the received information, and accommodate slower networks.

22. The methods of claims 1 or 12 wherein said information is simultaneously received by a plurality of users,
whereby the transmission bandwidth can be simultaneously shared by many users, thereby reducing network traffic.
